(19) United States
(12) Patent Application Publication
(10) Pub. No.: US 2010/0015353 A1
(43) Pub. Date: Jan. 21, 2010

(54) Method And Apparatus For Coating Polymeric Sheet During Its Manufacturing

(75) Inventors: Ronen Altman, Kibbutz Gazit (IL); Ehud Kedar, Ramat Yshai (IL); Shimon Weiner, Kibbutz Gazit (IL)

Correspondence Address: William H. Dippert;Eckert Seamans Cherin & Mellott, LLC, U.S. Steel Tower, 600 Grant Street, 44th Floor, Pittsburgh, PA, 15219, US

(73) Assignee: Plazit 2001 Ltd., Kibbutz Gazit (IL)

(21) Appl. No.: 12/174,744

(22) Filed: Jul. 17, 2008

(51) Int. Cl. C08F 2/46

(52) U.S. Cl. 427/521; 118/642

(57) ABSTRACT

An adjunct apparatus for coating moving sheets is provided within an in-line apparatus of manufacturing the sheets. The adjunct apparatus comprises at least one array of controlled orifices capable of producing jets of UV curable composition directed towards the sheets. The composition is cured by at least one UV radiation tube placed adjacent to the arrays of controlled orifices.

### FIELD OF THE INVENTION

The present invention relates to sheet coating technologies. More particularly, the present invention relates to method and apparatus for coating polymeric sheets during their manufacturing process.

### BACKGROUND OF THE INVENTION

Polymeric materials are one of the most important industrial products in use today. However, there is one significant limitation with most industrial polymers and especially with sheets of polymers that are widely used—the difficulty of coating polymers in order to provide capabilities such as anti-corrosion, anti-abrasion, anti-icing, anti-scratch, anti-fog, anti-stain, etc. There is a vast need to render polymeric surfaces of shaped articles, plates and films based on thermoplastic polymers the mentioned capabilities and other characteristics such as color effect, light conduction, or self-cleaning by coating them with a protective or additive layer.

One of the known methods of coating polymeric surfaces with a protective layer is by applying the laminating layer that is based on UV curable composition on the polymeric surface and curing it on the surface itself. The coating material can be applied to the surface by any of many known coating methods such as spraying, flow coating, curtain coating, or dipping. Then, a curing process using UV radiation is taking place wherein the choice of process is determined according to the curable composition. An example of such process is disclosed in U.S. Pat. No. 5,455,105 “Acrylic coated polycarbonate article” by Coyle et al. wherein the uncured coating material is applied to the substrate, heated along with the substrate in order to drive a portion of the coating material into the region beneath the surface of the substrate, and cured onto the substrate by exposure to ultraviolet radiation.

This specific process as other processes is designed to overcome one of the inherent problems of coatings that is the stability and durability of the coating in the environment while in use. However, besides this problem that is not fully resolved, there are other factors that are not addressed in the available coating technologies and other patents such as over processing of the substrate that is being processed all over again during the process of coating it and coating a polymeric sheet on both sides in one process.

### SUMMARY OF THE INVENTION

It is an object of the present invention to provide a method of rapidly coating polymeric substrates during their manufacturing process.

It is another object of the present invention to provide a coating apparatus incorporated within the line of polymeric films manufacturing.

It is yet another object of the present invention to provide an apparatus for coating polymeric substrates using fluid jets array.

In addition, it is an object of the present invention to provide a method of homogeneously coating a polymeric sheet using fluid jets array.

It is yet another object of the present invention to provide an apparatus for rapid curing the coated layer composition using UV radiation.

Yet, it is another object of the present invention to provide an apparatus for coating polymeric sheet during processing wherein both sides of a polymeric sheet is to be coated at the same time.

It is thus provided in accordance with the present invention, an adjunct apparatus for coating moving sheets provided within an in-line apparatus of manufacturing the sheets, the adjunct apparatus comprising:

at least one array of controlled orifices capable of producing jets of UV curable composition directed towards the sheets;

at least one UV radiation tube placed adjacent to said at least one array of controlled orifices.

Furthermore, in accordance with another preferred embodiment of the present invention, the polymeric sheets are 0.5 mm to 35 mm in thickness.

Furthermore, in accordance with another preferred embodiment of the present invention, at least one of said at least one array of controlled orifices is placed on top of the polymeric sheet.

Furthermore, in accordance with another preferred embodiment of the present invention, at least one of said at least one array of controlled orifices is placed beneath the polymeric sheet.

Furthermore, in accordance with another preferred embodiment of the present invention, two arrays of controlled orifices are provided, one positioned beneath the moving sheet and the other one is positioned on top of the moving sheet.

Furthermore, in accordance with another preferred embodiment of the present invention, at least one of said at least one UV radiation tube is placed on top of the polymeric sheet.

Furthermore, in accordance with another preferred embodiment of the present invention, at least one of said at least one UV radiation tubes is placed beneath the polymeric sheet.

Furthermore, in accordance with another preferred embodiment of the present invention, two UV radiation tubes are provided, one positioned beneath the moving sheet and the other one is positioned on top of the moving sheet.

Furthermore, in accordance with another preferred embodiment of the present invention, the polymeric sheet is moving in the in-line apparatus of manufacturing in velocity between 15-60 cm/min.

Furthermore, in accordance with another preferred embodiment of the present invention, said at least one array of controlled orifices is arranged in oblique line relative to the direction of the moving sheet.

Furthermore, in accordance with another preferred embodiment of the present invention, said in-line apparatus of manufacturing sheets is provided with supporting cylinders that supports the moving sheets and wherein the distance between said cylinders is about 100 cm.

Furthermore, in accordance with another preferred embodiment of the present invention, said at least one array of controlled orifices is arranged so as to homogeneously cover a whole width of said sheet.

Furthermore, in accordance with another preferred embodiment of the present invention, said sheet is a polymeric sheet.

It is therefore also provided in accordance with yet another preferred embodiment of the present invention an apparatus for manufacturing coated polymeric sheets comprising:

an extruder capable of shaping a thermoplastic polymer into a polymeric sheet;

a cooling system capable of cooling the polymeric sheet so as to maintain its shape;

at least one array of controlled orifices capable of producing jets of UV curable composition directed towards the polymeric sheets;

at least one UV radiation tube placed adjacent to said at least one array of controlled orifices capable of curing the UV curable composition.

Furthermore, in accordance with another preferred embodiment of the present invention, the polymeric sheets are 0.5 mm to 35 mm in thickness.

Furthermore, in accordance with another preferred embodiment of the present invention, at least one of said at least one array of controlled orifices is placed on top of the polymeric sheet.

Furthermore, in accordance with another preferred embodiment of the present invention, at least one of said at least one array of controlled orifices is placed beneath the polymeric sheet.

Furthermore, in accordance with another preferred embodiment of the present invention, at least one of said at least one array of controlled orifices is placed beneath the polymeric sheet and another one of said at least one array of controlled orifices is placed on top of the polymeric sheet.

Furthermore, in accordance with another preferred embodiment of the present invention, the polymeric sheet is moving within the apparatus in velocity between 15-60 cm/min.

It is also provided in accordance with another preferred embodiment of the present invention a method of coating a polymeric sheet during its manufacturing, the method comprises:

extruding the polymeric sheet of a thermoplastic polymer;

partially cooling the polymeric sheet;

providing at least one array of controlled orifices capable of producing jets;

directing UV curable composition and producing an homogeneous layer of the composition onto the polymeric sheets;

curing the composition using a UV tube.

Furthermore, in accordance with another preferred embodiment of the present invention, the method further comprises positioning one of the controlled orifices beneath the polymeric sheet travel route and positioning another one of the controlled orifices on top of the polymeric sheet travel route.

Additionally, in accordance with another preferred embodiment of the present invention, the method further comprises positioning UV lamps beneath and on top of the moving sheet.

### BRIEF DESCRIPTION OF THE FIGURES

In order to better understand the present invention and appreciate its practical applications, the following Figures are attached and referenced herein. Like components are denoted by like reference numerals.

It should be noted that the figures are given as examples and preferred embodiments only and in no way limit the scope of the present invention as defined in the appending Description and Claims.

FIG. 1 illustrates a side view of an apparatus for extruding polymeric sheets incorporated with a coating apparatus.

FIG. 2 illustrates an upper view of the apparatus shown in FIG. 1, showing an array of fluid jets.

### DETAILED DESCRIPTION OF THE INVENTION AND FIGURES

The present invention provides a unique and novel apparatus for coating polymeric substrates with a layer of composition that can be cured using UV radiation. The coating process is designed to protect the surface of the polymeric substrate with a protective layer such as anti-scratch or anti-abrasion or to add a certain characteristic to the surface such as color.

The new coating apparatus of the present invention is designed to be incorporated in existing lines for extruding polymer sheets. The incorporation of the new apparatus within the manufacturing lines is beneficial in several aspects. The coating process is rapid and the capacity of coating is relatively high when using a UV curing of the coating composition. Incorporating the two processes together saves enormous amount of energy. It is expected to use about fifth of the energy consumption that is used in the coating processes that are currently in use.

Moreover, since the two processes are incorporated together, the polymeric material is still hot or warm when the coating process takes place and therefore, the adhesion of the protective layer is better forming a layer that is durable and more stable then existing coating layers.

The use of UV curable composition renders the protective or other layer with better homogeneity characteristics in compared to spraying processes for coating since there is no process of evaporation of solvents.

Another issue that is addressed and solved by using UV curable compositions for coating is the use of environment safe processes in which there is no evaporation of solvents that are usually harmful for the environment.

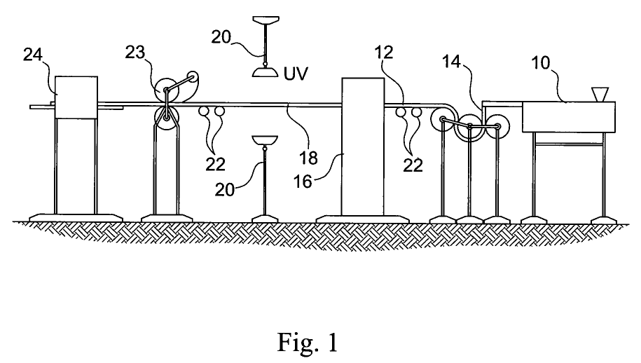

Reference is now made to FIG. 1 illustrating a side view of an apparatus for extruding polymeric sheets incorporated with a coating apparatus. The coating apparatus is combined within existing and well known extruders 10 in which polymeric sheets are manufactured. The polymeric sheet 12 passes through a cooling system 14 by which polymeric sheet 12 is cooled in a certain extent.

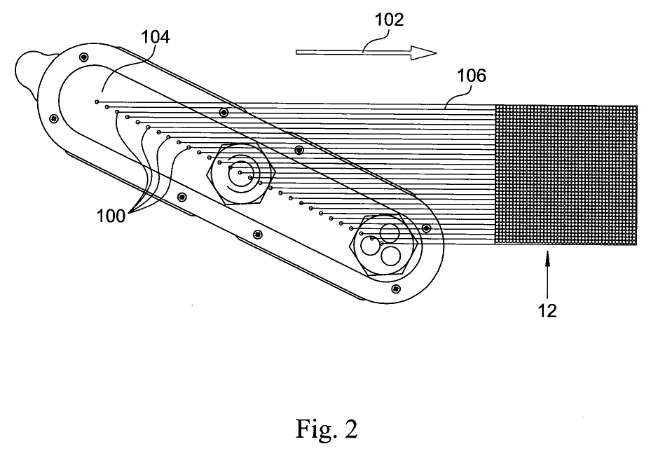

Then the moving polymeric sheet 12 passes through a coating system 16 that is incorporated within the manufacturing line. The interior portion of the coating system will be shown herein after; coating system 16 comprises an array of fluid jets (cannot be seen in FIG. 1, shown in FIG. 2). The fluid jets are based on relatively small orifices that may form jets of liquids that are controlled using valves that control each jet. Such jets are manufactured by Matthews Marking Products, as an example, which produces electromechanical printer heads (Jet-A-Mark) having relatively high jet speeds that is essential to the coating process. Electromechanical devices based on the printer's technologies can be employed in the coating system shown herein. It is important to notice that the jets can be provided either on the upper side of the polymeric sheet, the bottom side, or both sides. One of the benefits of the present invention is in saving coating material compared with traditional pressure sprays. In the present invention, the usage of the coating materials is in the range of 100% use versus 50% to 80% in the traditional methods.

After the coating material is spread on polymeric sheet 12, it passes through US lamps 20 that are positioned, one on top of the polymeric sheet and another beneath the polymeric sheet. UV lamps 20 are activated according to the need and the covered area that is being cured. The lamps are used in order to cure the polymeric coating that is being sprayed on the sheet.

Reference is now made also to FIG. 2 illustrating an upper view of the apparatus shown in FIG. 1, showing an array of fluid jets. The jets 100 that are controlled orifices are preferably arranged in an oblique line relative to the direction of the moving sheet that is represented by an arrow 102. The plurality of jets 100 are arranged within a housing 104 that is provided within coating system 16 that is shown in FIG. 1. As sheet 12 is traveling beneath jets 100, it is homogeneously coated by the coating material 106. It should be emphasized that coating system 16 is preferably provided with two coating jets from both sides of the polymeric sheet so as to provide a polymeric sheet that is coated from both sides equally.

Using ink-jets in coating processes was disclosed in PCT application published as WO 03/009013 “Transparent article” by Hydrophilm limited. They disclose a method of producing a transparent article comprised of a transparent based substrate and a surface coating of a transparent resin wherein the resin is applied to the base substrate by means of a jet printer. However, this patent application deals with very thin articles that cannot be coated during their manufacturing process and are basically having relatively smaller surfaces (windows for display devices). Using this technology, one can only apply a coating to the upper surface side, based on performances of piezoelectric ink-jets.

It should be mentioned that the invented technology is to be applied in the manufacturing of polymeric sheets of thickness that ranged between 0.5 mm to 35 mm. The typical velocity of such sheets in an existing extrusion apparatus is about 160 cm/min for a 3 mm sheet thickness to 15 cm/min for 30 mm thickness. For in line coating purposes, very small quantities of coating materials is to be applied; in the range of 1-10 cc for SQM by min. The invented apparatus addresses the application of such small amounts in-line using the jets that can be adequately controlled.

One of the limitations in such extrusion lines that is addressed in the present invention is that the moving polymeric sheet has to be supported by metal cylinders 22 as shown in FIG. 1, wherein the cylinders prevent the sheet from collapsing due to its own weight and gravity. The spaces between these cylinders are in the range of 100 cm at the time the continuous sheet is cooled. Since the incorporated coating system has to be limited to those spaces, only the new jet technology can be applied to the coating system in order to overcome the coating difficulties. Using the jet coating technology as presented herein before, it is possible to provide a uniform coated layer of 3-20 microns thickness.

As mentioned herein before, the coated polymeric sheet 18 that is discharged from coating system 16 is now passed through a UV radiation device 20. UV radiation device is preferably based on a quartz tube filled with argon and mercury vapor wherein the pressure of the mercury vapor is about 1-2 atm. The tube is capable of radiating UV rays that are preferably passed through a reflector capable of converging or diverge the radiation so that the area that is radiated can be controlled in accordance with the travel velocity of the polymeric sheet.

As used in the industry, polyethylene cover protection film is applied using a dedicated system 23 and the sheets are cut using a saw 24.

Optionally, a cooling system for the tube can be added as well as a system for eliminating ozone gasses that may be formed in the vicinity of the tube.

Optionally, filters as well known in the art can be incorporated in the UV radiation system in order to improve the curing process.

It should be emphasized that the coating process is performed when the polymeric sheet is during its cooling process and can be maintained in a temperature range of 50-80 centigrade. This feature facilitates the adhesion process of the layer to the surface of the polymeric sheet.

Optionally, more then one layer can be spread onto the surface of the polymeric sheet in order to form a multilayered protective polymeric sheet. In order to design more than one layer, more than one array of jets can be arranged, so one coating is cover by a second layer from an overlapped jet array.

It should be mentioned that the coating system can be manufactured with the extrusion apparatus or as an adjunct to an existing extrusion apparatus without limiting the scope of the present invention.

It should be clear that the description of the embodiments and attached Figures set forth in this specification serves only for a better understanding of the invention, without limiting its scope as covered by the following Claims.

It should also be clear that a person skilled in the art, after reading the present specification can make adjustments or amendments to the attached Figures and above described embodiments that would still be covered by the following Claims.

1. An adjunct apparatus for coating moving sheets provided within an in-line apparatus of manufacturing the sheets, the adjunct apparatus comprising:
at least one array of controlled orifices capable of producing jets of UV curable composition directed towards the sheets;
at least one UV radiation tube placed adjacent to said at least one array of controlled orifices.

2. The adjunct apparatus as claimed in claim 1, wherein the polymeric sheets are 0.5 mm to 35 mm in thickness.

3. The adjunct apparatus as claimed in claim 1, wherein at least one of said at least one array of controlled orifices is placed on top of the polymeric sheet.

4. The adjunct apparatus as claimed in claim 1, wherein at least one of said at least one array of controlled orifices is placed beneath the polymeric sheet.

5. The adjunct apparatus as claimed in claim 1, wherein two arrays of controlled orifices are provided, one positioned beneath the moving sheet and the other one is positioned on top of the moving sheet.

6. The adjunct apparatus as claimed in claim 1, wherein at least one of said at least one UV radiation tube is placed on top of the polymeric sheet.

7. The adjunct apparatus as claimed in claim 1, wherein at least one of said at least one UV radiation tubes is placed beneath the polymeric sheet.

8. The adjunct apparatus as claimed in claim 1, wherein two UV radiation tubes are provided, one positioned beneath the moving sheet and the other one is positioned on top of the moving sheet.

9. The adjunct apparatus as claimed in claim 1, wherein the polymeric sheet is moving in the in-line apparatus of manufacturing in velocity between 15-60 cm/min.

10. The adjunct apparatus as claimed in claim 1, wherein said at least one array of controlled orifices is arranged in oblique line relative to the direction of the moving sheet.

11. The adjunct apparatus as claimed in claim 1, wherein said in-line apparatus of manufacturing sheets is provided with supporting cylinders that supports the moving sheets and wherein the distance between said cylinders is about 100 cm.

12. The adjunct apparatus as claimed in claim 1, wherein said at least one array of controlled orifices is arranged so as to homogeneously cover a whole width of said sheet.

13. The adjunct apparatus as claimed in claim 1, wherein said sheet is a polymeric sheet.

14. An apparatus for manufacturing coated polymeric sheets comprising:
an extruder capable of shaping a thermoplastic polymer into a polymeric sheet;
a cooling system capable of cooling the polymeric sheet so as to maintain its shape;
at least one array of controlled orifices capable of producing jets of UV curable composition directed towards the polymeric sheets;
at least one UV radiation tube placed adjacent to said at least one array of controlled orifices capable of curing the UV curable composition.

15. The apparatus as claimed in claim 14, wherein the polymeric sheets are 0.5 mm to 35 mm in thickness.

16. The apparatus as claimed in claim 14, wherein at least one of said at least one array of controlled orifices is placed on top of the polymeric sheet.

17. The apparatus as claimed in claim 14, wherein at least one of said at least one array of controlled orifices is placed beneath the polymeric sheet.

18. The apparatus as claimed in claim 14, wherein at least one of said at least one array of controlled orifices is placed beneath the polymeric sheet and another one of said at least one array of controlled orifices is placed on top of the polymeric sheet.

19. The apparatus as claimed in claim 14, wherein the polymeric sheet is moving within the apparatus in velocity between 15-60 cm/min.

20. A method of coating a polymeric sheet during its manufacturing, the method comprises:
extruding the polymeric sheet of a thermoplastic polymer;
partially cooling the polymeric sheet;
providing at least one array of controlled orifices capable of producing jets;
directing UV curable composition and producing an homogeneous layer of the composition onto the polymeric sheets;
curing the composition using a UV tube.

21. The method as claimed in claim 20, further comprising positioning one of the controlled orifices beneath the polymeric sheet travel route and positioning another one of the controlled orifices on top of the polymeric sheet travel route.

22. The method as claimed in claim 20, further comprising positioning UV lamps beneath and on top of the moving sheet.
